(19) United States
(12) Patent Application Publication
(10) Pub. No.: US 2007/0005467 A1
(43) Pub. Date: Jan. 4, 2007

(54) System and method for carrying out a financial transaction

(75) Inventors: Christopher Haigh, San Francisco, CA (US); Christopher Sorenson, Lake Forest, IL (US)

Correspondence Address: David B. Ritchie;Thelen Ried and Priest, P.O. Box 640640, San Jose, CA, 95164-0640, US

(73) Assignee: SVC Financial Services, a California corporation

(21) Appl. No.: 11/174,136

(22) Filed: Jun. 30, 2005

(51) Int. Cl. G06Q 40/00

(52) U.S. Cl. 705/35

(57) ABSTRACT

To carry out a financial transaction between a first financial account and a second financial account, at least a portion of a first telephone number is associated with the first financial account. At least a portion of a second telephone number is associated with the second financial account. A transaction request applicable to the first and second financial accounts is received. The transaction request includes at least a representation of the first telephone number, a representation of the second telephone number, and a representation of a transaction amount. The transaction request is authenticated using at least a portion of the first telephone number and carried out in response to the authentication.

### FIELD OF THE INVENTION

The present invention relates to financial transactions. More particularly, the present invention relates to a system and method for carrying out a financial transaction.

### BACKGROUND

Billions of financial transactions occur between individuals and institutions every year. In particular, for individuals without a bank account, cash transactions are burdened by the need to have the correct amount of cash or by the need to provide change. Furthermore, the handling and managing of paper cash and coins is inconvenient, costly and time consuming for both individuals and financial institutions.

An individual without a bank account seeking to send money to a family member located in another country would typically carry out such a transaction by paying a fee based on the amount transferred to a local branch of a financial institution. The individual would then contact the family member to pick up the money from a respective local branch of the financial institution. Such transactions are costly and time-consuming.

With the current advances and popularity in cellular telephone usage, it would be desirable to allow an individual without a bank account to use his or her existing wireless telephone to instantly make purchases and send remittances to other users worldwide based only on the recipient's phone number. Accordingly, a need exists for a system and method for carrying out a financial transaction for individuals without bank accounts. A primary purpose of the present invention is to solve these needs and provide further, related advantages.

### BRIEF DESCRIPTION OF THE INVENTION

To carry out a financial transaction between a first financial account and a second financial account, at least a portion of a first telephone number is associated with the first financial account. At least a portion of a second telephone number is associated with the second financial account. A transaction request applicable to the first and second financial accounts is received. The transaction request includes at least a representation of the first telephone number, a representation of the second telephone number, and a representation of a transaction amount. The transaction request is authenticated using at least a portion of the first telephone number and carried out in response to the authentication.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram schematically illustrating a system for a carrying out a financial transaction in accordance with one embodiment.

FIG. 2 is a block diagram schematically illustrating a server for a carrying out a financial transaction in accordance with one embodiment.

FIG. 3 is a block diagram schematically illustrating a system for carrying out a financial transaction in accordance with another embodiment.

FIG. 4 is a flow diagram schematically illustrating a method for processing a financial transactional request in accordance with one embodiment.

FIG. 5 is a flow diagram schematically illustrating a method for associating a portion of a telephone number with a financial account in accordance with one embodiment.

FIG. 6 is a flow diagram schematically illustrating a method for activating a financial account associated with a telephone number in accordance with one embodiment.

FIG. 7 is a flow diagram schematically illustrating a method for depositing funds into a financial account associated with a telephone number in accordance with one embodiment.

FIG. 8 is a flow diagram schematically illustrating a method for requesting a balance of a financial account associated with a telephone number in accordance with one embodiment.

FIG. 9 is a flow diagram schematically illustrating a method for requesting a balance of a financial account associated with a telephone number in accordance with another embodiment.

FIG. 10 is a flow diagram schematically illustrating a method for withdrawing funds from a financial account associated with a telephone number in accordance with one embodiment.

FIG. 11 is a flow diagram schematically illustrating a method for purchasing with a financial account associated with a telephone number in accordance with one embodiment.

FIG. 12 is a flow diagram schematically illustrating a method for requesting find transfer from a first financial account associated with a first telephone number to a second financial account associated with a second telephone number in accordance with one embodiment.

### DETAILED DESCRIPTION

Embodiments of the present invention are described herein in the context of a system and method for carrying out a financial transaction. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

By combining a prepaid debit card and a mobile telephone number, a user can make purchases, and send remittances to other users. The prepaid card can be funded by many mechanisms, including, for example, direct deposit, debit card, check, ACH bank transfer, or cash at numerous check cashing and similar locations, and can be used at any merchant that accepts debit cards, and at ATMs (automated teller machine) worldwide.

A user can access his card account with his existing mobile telephone (or any telephone) to view his current cash balance. A user can also send person-to-person remittances worldwide, make payments for goods and services based only on the recipient's telephone number, or send money to any other participating card account.

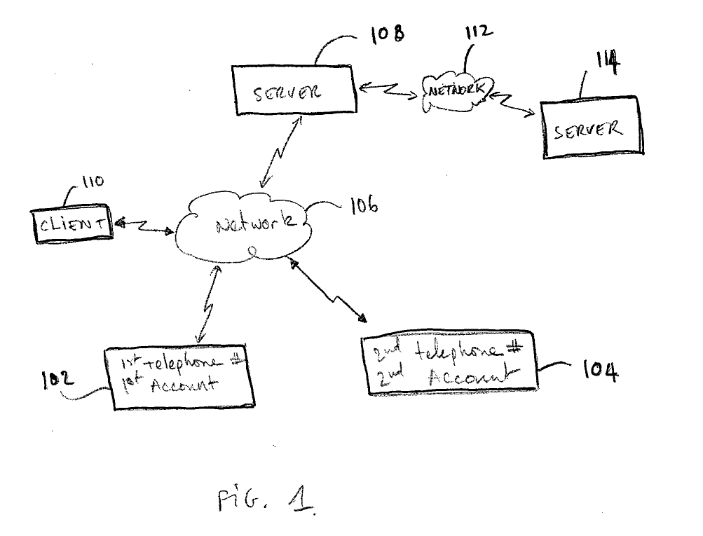

FIG. 1 illustrates a system 100 for a carrying out a financial transaction between a first financial account and a second financial account. A portion of a first telephone number of a first telephone 102 associated with a first financial account communicates with a server 108 via a data/telephone network 106. A portion of a second telephone number of a second telephone 104 associated with a second financial account communicates with server 108 via data/telephone network 106. First telephone 102 and second telephone 104 may include a land-based telephone, a mobile cellular telephone, or the like.

Server 108 may also communicate with a computer 110 via a data communications network 112 such as the Internet or another network, and with a server at a financial institution 114. Server 108 receives a transaction request applicable to the first and second financial accounts. The transaction request may include at least a representation of the first telephone number, a representation of the second telephone number, and a representation of a transaction amount. Server 108 authenticates the transaction request using at least a portion of the first telephone number. The authentication process is discussed further below. Upon authentication, server 108 carries out the transaction request by communicating with financial institution 114. In accordance with another embodiment, server 108 may receive the transaction request from computer 110.

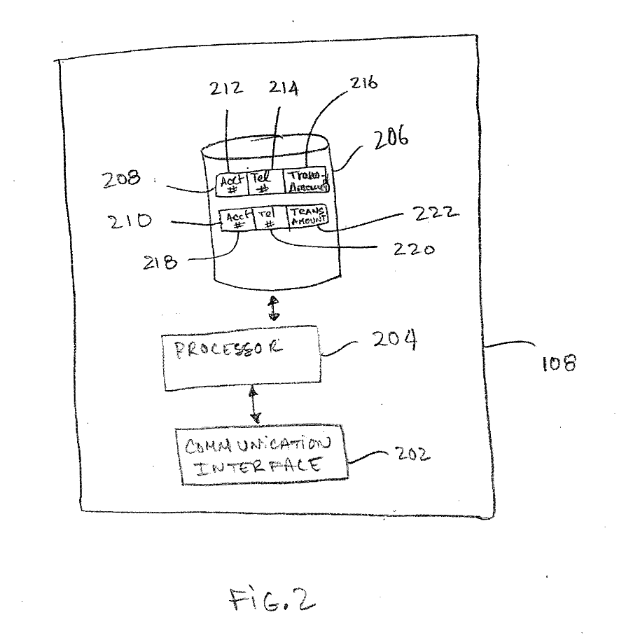

One embodiment of server 108 is further described and illustrated in FIG. 2. Server 108 may include a communication interface 202, a processor 204, and a database 206. The communication interface 202 allows server 108 to communicate with external devices through, for example, telephone network 106 or Internet 112. Those of ordinary skill in the art will now recognize that there exist many different types of communication interfaces. Processor 204 operates on the information received both from a user and the corresponding personal and financial information stored in database 206.

In accordance with one embodiment, database 206 includes a first set of information 208 associated with first telephone 102, and a second set of information 210 associated with second telephone 104. First set of information 208 may include an account number 212, a telephone number 214, and a transaction amount 216. Second set of information 210 may include an account number 218, a telephone number 220, and a transaction amount 222.

Upon authentication of the transaction request from first telephone 102 and verification of availability of the funds in the financial account associated with the first telephone 102, processor 204 updates database 206 to reflect the financial transaction. For example, a request to transfer a transaction amount from first telephone 102 to second telephone 104 is accomplished by debiting transaction amount 216 from account number 212 associated with telephone number 214 and crediting transaction amount 222 from account number 218 associated with telephone number 220.

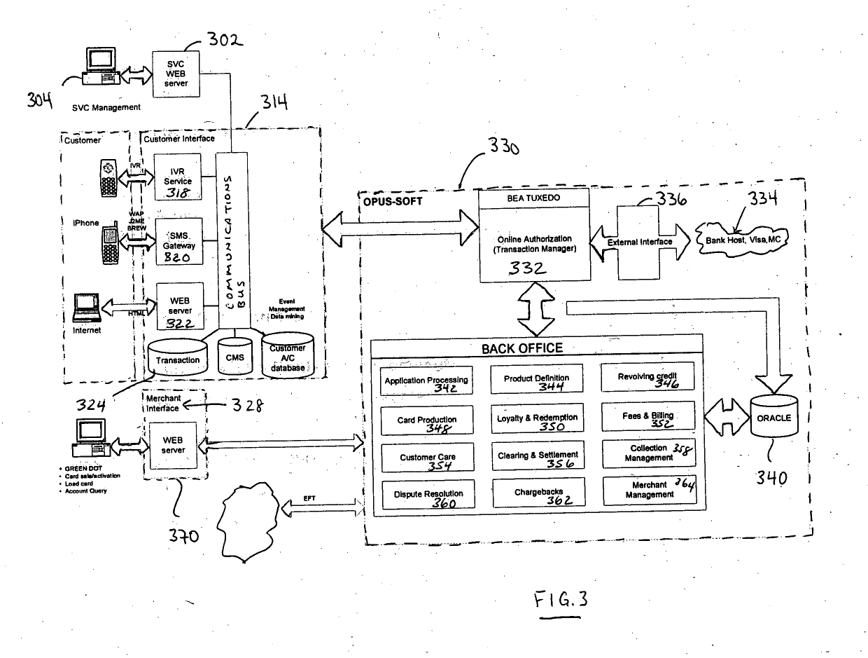

FIG. 3 illustrates another embodiment of a system for a carrying out a financial transaction between a first financial account and a second financial account. A web server 302 may be accessed through a computer 304 coupled to it. The server 302 communicates with a customer interface 314 that includes an IVR (Interactive Voice Response) service 318, an SMS (Short Message Service) gateway 320, a web server 322, and several databases 324. IVR service 318 communicates with a landline based customer telephone 308. SMS gateway 320 communicates with a customer mobile phone 310 capable of generating data messages, such as SMS. Web server 322 communicates with a computer 312 via the internet. Database 324 may include a transaction database and customer financial information database.

Customer interface 314 communicates with another financial transaction server 330 to carry out any financial transaction requests. Transaction server 330 includes a transaction manager 332 that provides online authorization of financial transaction requests. Transaction manager 332 communicates via an external interface 336 with a third party financial institution 334 such as a bank host, or a credit card host. Transaction manager 332 updates database 340 and communicates with a back office 338. Back office 338 includes several departments: an application processing department 342, a card protection department 348, a customer care department 354, a dispute resolution department 360, a product definition department 344, a loyalty and redemption department 350, a clearing and settlement department 356, a chargeback department 362, a revolving credit department 346, a fees and billing department 352, a collection management department 358, and a merchant management department 364. Financial transaction server 330 communicates with a merchant belong to a financial network via a merchant interface 328 that include a web server 370.

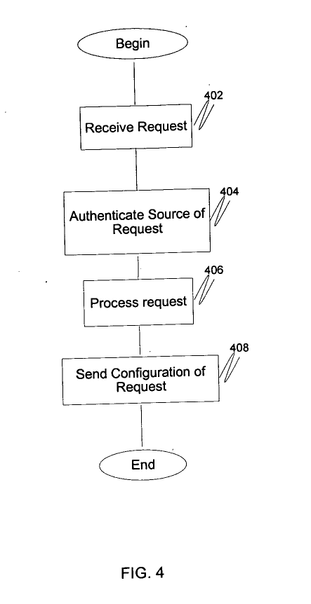

FIG. 4 illustrates a method for carrying out a financial transactional between a first financial account and a second financial account. At 402, at least a portion of a first telephone number is associated with the first financial account and at least a portion of a second telephone number is associated with the second financial account. At 404, a transaction request applicable to the first and second financial accounts is received. The transaction request includes at least a representation of the first telephone number, a representation of the second telephone number, and a representation of a transaction amount. At 406, the transaction request is authenticated using at least a portion of the first telephone number. At 408, the transaction request is carried out in response to the authentication.

A transaction request is received from a first telephone having a first telephone number associated with a first financial account. The transaction request may include a first telephone number, a second telephone number, and a transaction amount. The second telephone number is associated with a second financial account. At 404, the source of the transaction request may be authenticated using various methods of authentication as further described below. At 406, the transaction request is processed and carried out upon authentication at 404. A confirmation of the transaction request is sent out at 408, to, for example, the first and second telephone.

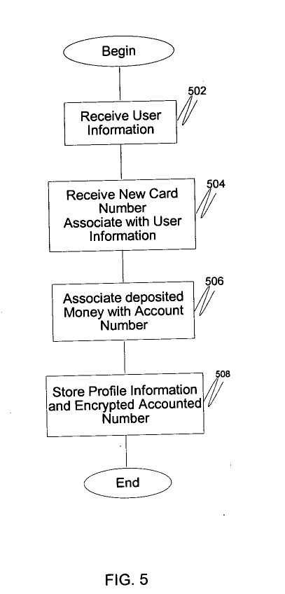

FIG. 5 illustrates a method for opening a financial account with a financial card. At 502, a user information is received. The user information may include a name, address, mobile telephone number, government issued identification number, a date of birth, security questions, email address, or the like. This information is screened for fraudulent applicants using a third party database and verified against public records in a conventional manner.

At 504, a new financial account number is associated with the user information. The financial account number may be obtained by purchasing a financial card from a convenience store or by mail. The merchant activates and loads the new financial card having a financial account using a swipe terminal connected to a processor via a financial network. The financial network is connected to a central financial server that processes the merchant request and activates the financial card number and PIN (personal identification number) number. The central financial server also credits the new account with any deposited value added to the card account. In accordance with one embodiment, the server of the present system creates a “real time load” by advancing money to the account and collecting the funds from the vendor/load station overnight via ACH (automated clearing house). As a way to prevent any loss, the central financial server may turn off the vendor immediately if ACH from the vendor/load station does not clear and resubmit ACH collection the next day.

At 506, the deposited funds are associated with the newly established account number. In accordance with one embodiment, the central financial server notifies the server of the present system that the card number has been activated and the new card balance. That information along with other data is being forwarded to the server of the present system. Other data may include, but are not limited to, a date, a load station name, a bank name, a transit routing number, an account number, a transaction amount.

At 508, the database of the server stores the received information along with an encryption of the card number for security purposes.

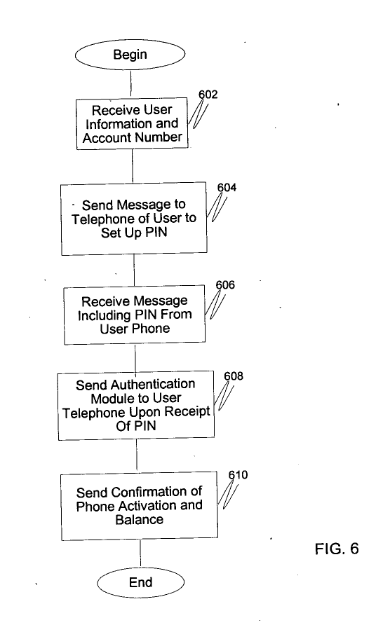

FIG. 6 is illustrates a method for activating a financial account associated with a telephone number. A user first calls the customer service department 354 of the central financial server 330 to associate the account with his telephone number. The user provides a name, address, card number and telephone number of a mobile telephone 310 or landline telephone 308 at 602. Upon receipt of the information, central financial server 330 notifies server 302.

At 604, server 302 sends a message, for example, such as an SMS message, to the user mobile telephone 310 with a link to set a user defined PIN number. The association of the telephone with the financial account is not activated until the PIN number is set. In case of a lost PIN or lost or stolen telephone, the user must authenticate himself to customer service with the name, address, identification number, and answer any security questions.

At 606, once the user has set up a PIN number on his telephone 310, the server receives a message from the user telephone 310 including the new PIN number. At 608, when the user PIN has been set, server 302 sends an SMS message that includes an authentication module or a link to download an authentication tool, such as a Verisign Mobile Certificate, that uniquely identifies the user's telephone handset.

At 608, server 302 also sends a confirmation SMS message to the user information him that his telephone financial account has been activated. The message may include for example, the current balance information and a special welcome promotional message if appropriate.

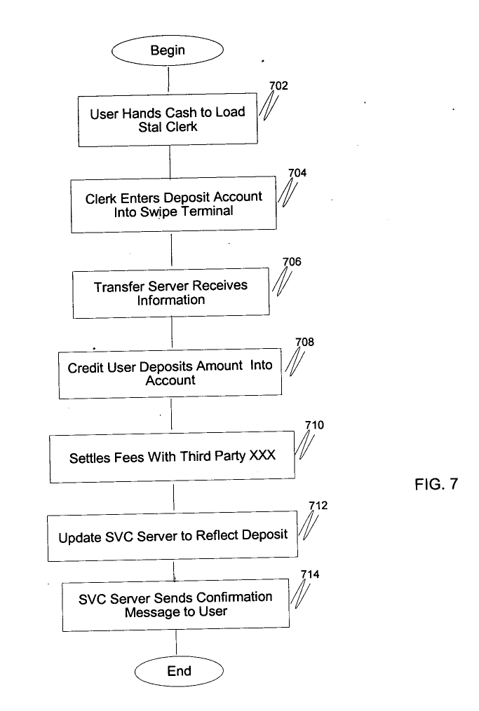

FIG. 7 illustrates a method for depositing funds into a financial account associated with a telephone number. After the telephone financial account has been activated, the financial card may be loaded by the user. For example, a user may hand cash to a load station clerk at 702. At 704, the station clerk enters the deposit amount into a swipe terminal or web page, and swipes the user's financial card. At 706, central financial server 330 receives the swipe information from a third party financial network such. At 708, central financial server 330 credits the user financial card account with the deposit amount. At 710, central financial server 330 settles fees with involved entities (distributors, third parties, etc. . . . ). Central financial server 330 collects the total aggregated deposited amount from the load station bank account via ACH and credits a master bank account associated with server 302. At 712, central financial server 330 also updates server 302 by sending a real time post transaction. The database of server 302 is updated with the new transaction and balance amount. At 714, server 302 automatically generates a confirmation message sent, for example, via SMS. The confirmation message may include the deposit amount and a new balance information along with some promotional messages.

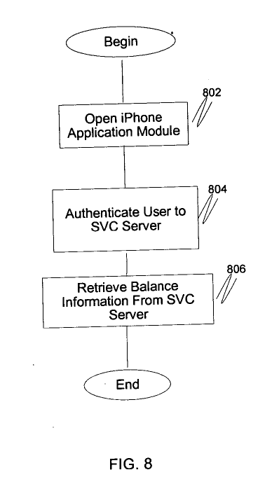

FIG. 8 illustrates a method for requesting a balance of a financial account associated with a telephone number in accordance with a first embodiment. Once the telephone financial account is activated, a user may query the balance on the financial account associated with the telephone number using his mobile telephone handset. At 802, a user may run a financial module application on his mobile telephone. The financial module application automatically authenticates the user to server 302 and retrieves the balance information from server 302. The financial module enables the user mobile telephone to be automatically identified and authenticated by server 302.

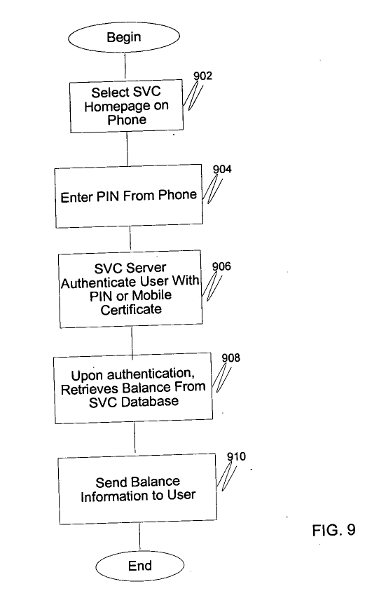

FIG. 9 illustrates a method for requesting a balance of a financial account associated with a telephone number in accordance with a second embodiment. At 902, a user selects the home web page of server 302 using a web interface on his mobile telephone handset. At 904, the user enters a PIN number to authenticate himself and retrieve information about the financial account associated with the mobile handset telephone number. At 906, server 302 authenticates the user with the received PIN number or with a mobile certificate of authenticity. At 908, upon authentication, server 330 retrieves the balance from the database of server 330. At 910, server 302 sends the the balance information to the user, for example, through a WAP (wireless application protocol) interface.

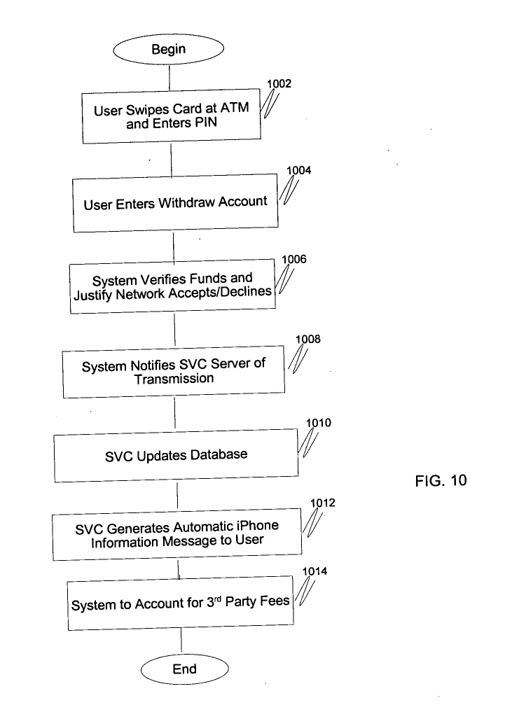

FIG. 10 illustrates a method for withdrawing funds from a financial account associated with a telephone number. The financial card is available for ATM withdrawals after activation. At 1002, a user may swipe the financial card at an ATM communicating with a third party financial network and enters the corresponding ATM PIN number. At 1004, the user enters the withdrawal amount. At 1006, central financial server 330 verifies funds and notifies the third party financial network whether to accept or decline the transaction. At 1008, central financial server 330 notifies server 302 of the transaction. At 1010, server 302 updates its database based on the information received. At 1012, server 302 generates an automatic message to the mobile telephone of the user. At 1014, central financial server 330 accounts for ATM fees between the ATM owner, the third party financial network, and server 302.

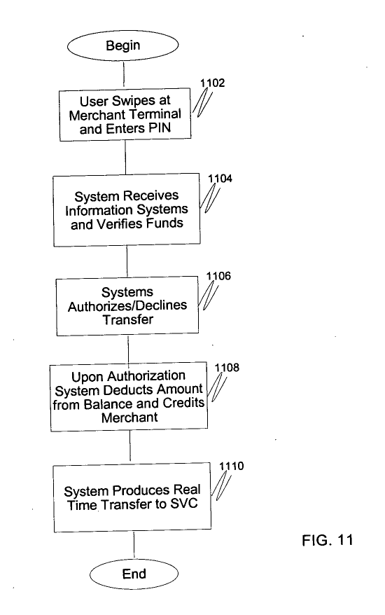

FIG. 11 illustrates a method for purchasing with a financial account associated with a telephone number. The financial card is also available for purchase use after it has been activated. At 1102, a user swipes the financial card at a merchant terminal and enters an ATM PIN that was previously selected by the user. At 1104, central financial server 330 receives the information from the user and verifies the funds available in the financial account associated with the financial card. At 1106, central financial server 330 authorizes or declines the requested transaction based on the information from the user and the retrieved balance information from the financial account and notifies server 302. At 1108, upon authorization, central financial server 330 deducts the transaction amount from the balance and credits the merchant. At 1110, the transaction is posted in real-time to server 302 which updates its database. Server 302 generates an automatic message to the mobile handset of the user. Central financial server 330 accounts for any point of service fees between the server 302, 3^{rd} party financial networks, and central financial server 330.

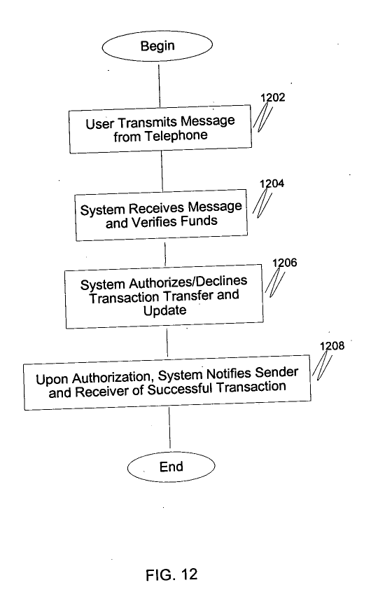

FIG. 12 illustrates a method for requesting fund transfer from a first financial account associated with a first telephone number to a second financial account associated with a second telephone number. At 1202, a first user transmits a message from his mobile telephone. The message may include, but is not limited to, a transaction amount, the second telephone number. At 1204, server 302 receives the first user message via customer interface 314 and checks its database to verify whether sufficient funds are available in the first financial account. At 1206, if the funds are available, server 302 notifies central financial server 330 and provide the first and second financial account numbers and the transaction amount. Central financial server 302 authorizes or declines the transaction and notifies server 302. At 1208, upon successful authorization, server 302 notifies the first user of the successful transfer and updates its database records for the first user (sender) and the second user (recipient). The second user accepts the transfer using his PIN number in order to complete the transfer process. The first user's financial account is not debited until the transfer is accepted. When the recipient accepts the transaction, server 302 sends a confirmation message to the first user.

In accordance with another embodiment, a user may receive an SMS message which may include a link to download a commercial promotion. The user may click to accept the promotion (for example, to buy specially priced tickets). Server 302 checks that user has sufficient funds. Server 302 notifies central financial server 330 a financial card transaction between the user financial account and the advertiser financial account on the server 302. Central financial server 330 debits the user financial account and credits the advertiser financial account in the amount of the purchase transaction. Central financial server 330 deducts any additional fees from the advertiser financial account and notifies server 302 with a transaction status (either as successful or fail) and the new balance on the user financial account. Server 302 generates a confirmation message to the user.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for carrying out a financial transaction between a first financial account and a second financial account, the method comprising:
associating at least a portion of a first telephone number with the first financial account and at least a portion of a second telephone number with the second financial account;
receiving a transaction request applicable to the first and second financial accounts, the transaction request including at least a representation of the first telephone number, a representation of the second telephone number, and a representation of a transaction amount;
authenticating the transaction request using at least a portion of the first telephone number; and
carrying out the transaction request in response to said authenticating.

2. The method of claim I wherein the transaction request also includes a representation of a transaction type.

3. The method of claim 1 further comprising receiving the transaction request from a first telephone associated with the first telephone number.

4. The method of claim 1 further comprising sending a message to a message account associated with the second telephone number.

5. The method of claim 4 wherein the message includes an advice of the transaction request, the advice including at least the transaction amount.

6. The method of claim 3 further comprising uploading a firmware module onto the first telephone, the firmware module uniquely identifying the first telephone.

7. The method of claim 6 wherein the firmware module includes a personal identification number (PIN) associated with the first telephone.

8. The method of claim 7 wherein said authenticating further comprises:
identifying the first telephone using the firmware module;
requesting a user to enter a PIN; and
verifying the entered PIN with a PIN associated with the first telephone.

9. The method of claim 2 wherein the transaction type includes a balance inquiry.

10. The method of claim 2 wherein the transaction type includes a transfer of the transaction amount from the first financial account to the second financial account.

11. The method of claim 9 wherein said carrying out further comprises sending a communication to a server associated with the first financial account, the communication instructing the server to send a message including the balance of the first financial account to a message account associated with the first telephone number.

12. The method of claim 10 wherein said carrying out further comprises sending a communication to a server associated with the first financial account, the communication instructing the server to deduct the transaction amount from the first financial account and to add the transaction amount to the second financial account.

13. The method of claim 1 further comprising sending a message to a message account associated with the first telephone number, the message including a financial offer, the financial offer configured to be purchased with the first financial account associated with the first telephone number.

14. A server comprising:
a communication interface receiving a message from an identifiable source having at least a portion of a first telephone number associated therewith;
a database storing a first financial account information associated with the first telephone number, and a second financial account information associated with a second telephone number;
a processor coupled to said communication interface and said database,
wherein the message includes a transaction request applicable to the first and second financial accounts, the transaction request including at least a representation of the first telephone number, a representation of the second telephone number, and a representation of a transaction amount,
wherein the processor is configured to authenticate the transaction request and carry out the transaction request in response to the authentication.

15. The server of claim 14 wherein the transaction request also includes a representation of a transaction type.

16. The server of claim 15 wherein the transaction type includes a balance inquiry.

17. The server of claim 15 wherein the transaction type includes a transfer of the transaction amount from the first financial account to the second financial account.

18. The server of claim 16 wherein said processor sends a message including the balance of the first financial account to a message account associated with the first telephone number.

19. The server of claim 17 wherein said processor operates on said database to deduct the transaction amount from the first financial account and to add the transaction amount to the second financial account.

20. The server of claim 17 wherein said processor generates and sends a message to a message account associated with the first telephone number.

21. The server of claim 17 wherein said processor generates and sends a message to a message account associated with the second telephone number.

22. The server of claim 20 wherein the message includes an advice of the transaction request, the advice including at least the transaction amount.

23. The server of claim 21 wherein the message includes an advice of the transaction request, the advice including at least the transaction amount.

24. The server of claim 14 wherein said server sends a message to a message account associated with the first telephone number, the message including a financial offer, the financial offer configured to be purchased with the first financial account associated with the first telephone number.

25. A program storage device readable by a machine, tangibly embodying a program of instructions executable by the machine to perform a method for carrying out a financial transaction between a first financial account and a second financial account, the method including:
associating at least a portion of a first telephone number with the first financial account and at least a portion of a second telephone number with the second financial account;
receiving a transaction request applicable to the first and second financial accounts, the transaction request including at least a representation of the first telephone number, a representation of the second telephone number, and a representation of a transaction amount;
authenticating the transaction request using at least a portion of the first telephone number; and
carrying out the transaction request in response to said authenticating.
